(19) United States
(12) Patent Application Publication
(10) Pub. No.: US 2010/0268841 A1
(43) Pub. Date: Oct. 21, 2010

(54) USING HIGHER LAYER INFORMATION TO FACILITATE COEXISTENCE IN WIRELESS NETWORKS

(75) Inventors: Ariton E. XHAFA, Plano, TX (US); Yanjun SUN, Richardson, TX (US); Xiaolin LU, Plano, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/763,488

(22) Filed: Apr. 20, 2010

Related U.S. Application Data
(60) Provisional application No. 61/170,849, filed on Apr. 20, 2009.

(51) Int. Cl. G06F 15/16

(52) U.S. Cl. 709/231

(57) ABSTRACT

A system composed of a node configured to transmit a first data stream to a first device using a first protocol and a second data stream to a second device using a second protocol. The system is also composed of a controller in communication with the node. The controller is configured to prioritize a first packet of the first data stream prior to transmission of the first packet. The prioritization is based on application layer information of the first packet. If the application layer information of the first packet indicates that the priority of the first packet is lower than the priority of a second packet of the second data stream, the controller causes the node to transmit the second packet.

### CROSS-REFERENCE TO RELATED APPLICATION

The present application claims priority to U.S. Provisional Patent Application No. 61/170,849, filed on Apr. 20, 2009 (Attorney Docket No. TI-68015), which is hereby incorporated herein by reference.

This application also may contain subject matter that relates to the following commonly assigned co-pending application incorporated herein by reference: U.S. patent application Ser. No. 12/727,805, filed on Mar. 19, 2010 (Attorney Docket No. TI-67863).

### BACKGROUND

Mobile devices are able to access multiple networks using wireless protocols operating at close frequency bands. However, when a single device utilizes two or more wireless protocols, the proximity of the frequency bands may lead to interference between data sent using the protocols, which may cause problems with the simultaneous operation of the protocols. Specifically, out-of-band transmissions using one protocol may saturate a receiver using a second protocol, effectively blocking transmissions using the second protocol. Thus, coexistence of multiple protocols on a single device often is problematic.

A device utilizing two or more wireless protocols may determine which protocol to operate in based on the priority of a packet type to be sent using a particular protocol. However, a packet that generally is of a high-priority type may contain low-priority data. Thus, the device would recognize the packet as being high-priority and would utilize the wireless protocol corresponding to the packet to transmit the packet, despite the fact that the packet contains low-priority data, thereby wasting bandwidth and decreasing the transmission efficiency of the device.

### SUMMARY

The problems noted above are solved in large part by a system comprising a node configured to transmit a first data stream to a first device using a first protocol and a second data stream to a second device using a second protocol. The system also comprises a controller in communication with the node. The controller is configured to prioritize a first packet of the first data stream prior to transmission of the first packet. The prioritization is based on application layer information of the first packet. If the application layer information of the first packet indicates that the priority of the first packet is lower than the priority of a second packet of the second data stream, the controller causes the node to transmit the second packet.

Furthermore, the problems noted above are solved in large part by a system comprising a controller configured to prioritize a first packet prior to transmission of the first packet using a first protocol and a second packet prior to transmission of the second packet using a second protocol. The controller is further configured to compare the priorities of the first and second packets and indicate the packet having a higher priority. The controller determines the priority of at least one of the first packet and the second packet based on application layer information of the at least one of the first packet and the second packet.

Still further, the problems noted above are solved in large part by a method comprising receiving, by a controller, a first packet of a first data stream prior to transmission of the first packet using a first protocol. The method also comprises prioritizing, by the controller, the first packet based on application layer information of the first packet. The method further comprises indicating, by the controller to a node, whether the priority of the first packet is lower than the priority of a second packet of a second data stream. Still further, the method comprises transmitting, by the node, the second packet using a second protocol if the priority of the first packet is lower than the priority of the second packet.

### BRIEF DESCRIPTION OF THE DRAWINGS

For a detailed description of exemplary embodiments of the invention, reference will now be made to the accompanying drawings in which:

FIG. 1 shows an exemplary sequence of video frames in accordance with various embodiments;

FIG. 2 shows a block diagram of an illustrative system in accordance with various embodiments;

FIGS. 3a and 3b show exemplary coexistence operations in accordance with various embodiments; and

FIG. 4 shows a flow diagram of an illustrative method in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless connection. The term “WLAN” refers to a wireless local area network, for example, in the IEEE 802.11 protocol. The term BT refers to the Bluetooth® wireless protocol. The term “AP” refers to an access point, which may be a device that facilitates wireless communication in a wireless network and has a wired network connection. The term “CTS2Self” refers to a frame, which may reserve a period of network silence.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Switching between protocols is utilized to facilitate coexistence of multiple wireless technologies at a single node (e.g., a computer, PDA, smart phone). The priority of a data stream to be transmitted using one protocol relative to the priority of another data stream to be transmitted using a second protocol determines which data stream will be transmitted and which protocol will be used. For example, in the case of WLAN and Bluetooth® (BT) coexistence, BT voice calls, which comprise BT voice data packets, preferably take priority over other data traffic flows using WLAN. If there are BT voice data packets to be transmitted from the node, then the node will operate in the BT protocol to facilitate the transmission of these packets. As a result, any data packets to be transmitted using the WLAN protocol will not be transmitted until there are no more BT voice data packets to be transmitted.

However, not all voice data packets contain useful information. For example, when a speaker pauses, or ceases to speak, the transmitted voice data packets do not contain useful information since the packets do not contribute to the listener's understanding of the speaker. Additionally, voice data packets that merely contain background noise or white noise do not contribute to the listener's understanding of the speaker, and thus do not contain useful information. In other embodiments, various other criteria based on the intelligibility of the speech may be used to determine whether a voice data packet contains useful information. Although voice data packets generally have a priority that is higher than WLAN data packets, voice data packets that do not contain useful information should not have a priority that is higher than WLAN data packets, since these voice data packets do not contribute to the listener's understanding of the speaker.

In another example, streaming video data over WLAN preferably takes priority over a transmission using BT. If there are video data frames to be transmitted from the node using WLAN, then the node will operate in the WLAN protocol to facilitate the transmission of these packets. As a result, any packets to be transmitted using the BT protocol will not be transmitted until there are no more video data frames to be transmitted.

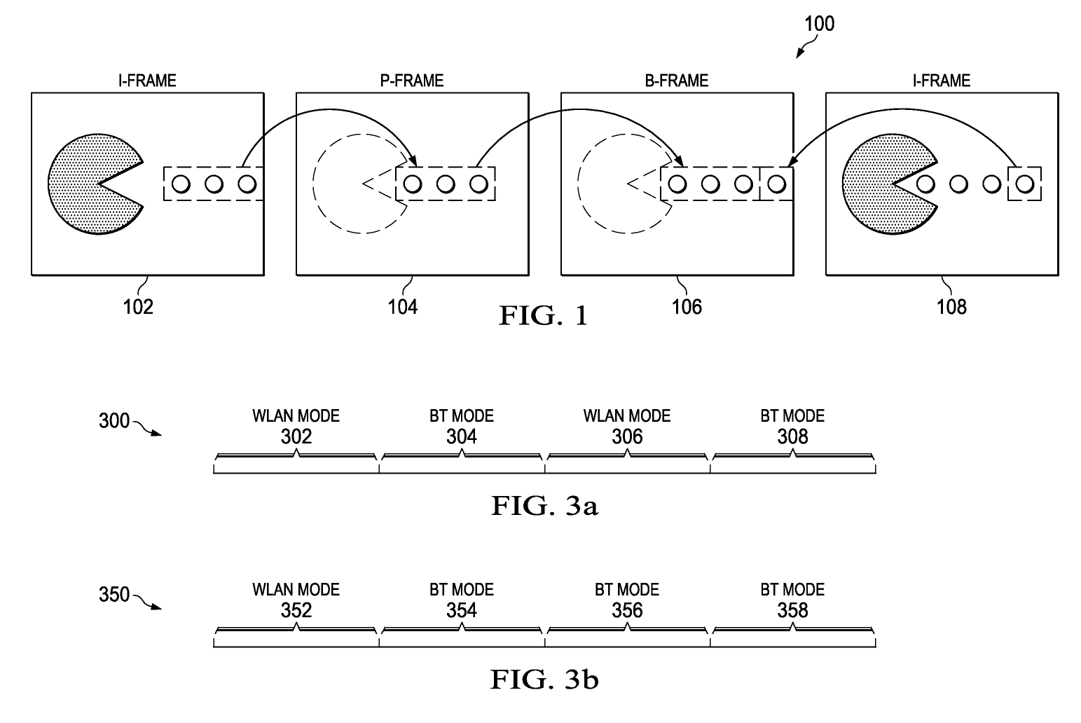

However, not all video data frames carry the same amount of information. FIG. 1 shows an exemplary sequence 100 of video data frames. For example, intra-coded frames (“I-frames”) 102, 108 are frames that are encoded without reference to any frames except themselves and can be decoded and are independent of other frames. I-frames 102, 108 are fully-specified images, similar to a conventional static image file. Predicted frames (“P-frames”) 104 are frames that are dependent on either an I-frame 102 or a previous P-frame; the information that is carried in the P-frame 104 is less than that of the previous I-frame 102. The P-frame 104 contains only the changes in the image from the previous frame 102; in this case, the dots that have moved closer to the wedge cut into the circle shown in frame 102. Bi-predictive frames (“B-frames”) 106 are frames that are interpolated from earlier and/or later I-frames 102, 108 and P-frames 104. The B-frame 106 may contain information of more than one frame (i.e., a combination of frames); in this case, the first three dots are from P-frame 104 and the newly-added fourth dot is from I-frame 108.

Reception of I-frames 102, 108 is important to the overall quality of a video transmission because it contains information about the whole image. However, reception of P-frame 104 or B-frame 106 is less important because the information carried in these frames does not represent the bulk of an image; thus, failing to receive P-frame 104 or B-frame 106 may not result in drastic reduction of video quality. In this way, P-frames and B-frames do not substantially contribute to a recipient's comprehension of the video information. In other embodiments, various other criteria based on the ability to recognize the video information being transmitted may be used to determine whether a video data frame contains less useful information. Although video data frames generally have a priority that is higher than BT data packets, video data frames that contain less useful information should not have a priority that is higher than BT data packets, since these video data frames do not substantially contribute to the recipient's comprehension of the video information.

In accordance with various embodiments, a particular type of data stream has a high priority level. However, individual packets of the particular data stream can be determined to be of little importance to the recipient, and thus should not be treated as being high-priority because of the packets' data stream type. Thus, information beyond a packet's data stream type is utilized to determine the priority of the packet.

In an exemplary embodiment, higher layer information (e.g., information from a subband codec (“SBC”)) of a voice data packet may be used to determine whether the voice data packet should have a priority that is higher than WLAN data packets. An SBC breaks a signal into a number of different frequency bands and encodes each one independently. For example, when no voice data arrives from a higher layer to the SBC, the SBC recognizes this and outputs a dummy voice packet. This information can be passed in the application layer of the packet to a coexistence controller, which determines that the voice packet is not useful. In an exemplary embodiment, the SBC passes this information in the application layer of a packet by setting a bit to “1” if the packet is a dummy voice packet.

In another example, the application layer may contain information that indicates the frame type (i.e., I-frame, P-frame, B-frame) of a video data frame, which indicates whether a video data frame should have a priority that is higher than BT data packets. In the case of video data, the application layer of the packet, specifically the video header, provides the information indicating what type of frame is being used. The coexistence controller determines that the video data frame is not useful if the video header indicates that the frame is a P-frame or a B-frame. In either the BT voice data case or the WLAN video data case, transmission efficiency may be increased and finer granularity for packet prioritization achieved by electing not to transmit the data packet that is not useful and instead transmitting a pending data packet using a different protocol. The above description is exemplary, and packets of other data stream types may be similarly analyzed to determine whether to transmit the packets, despite their priority.

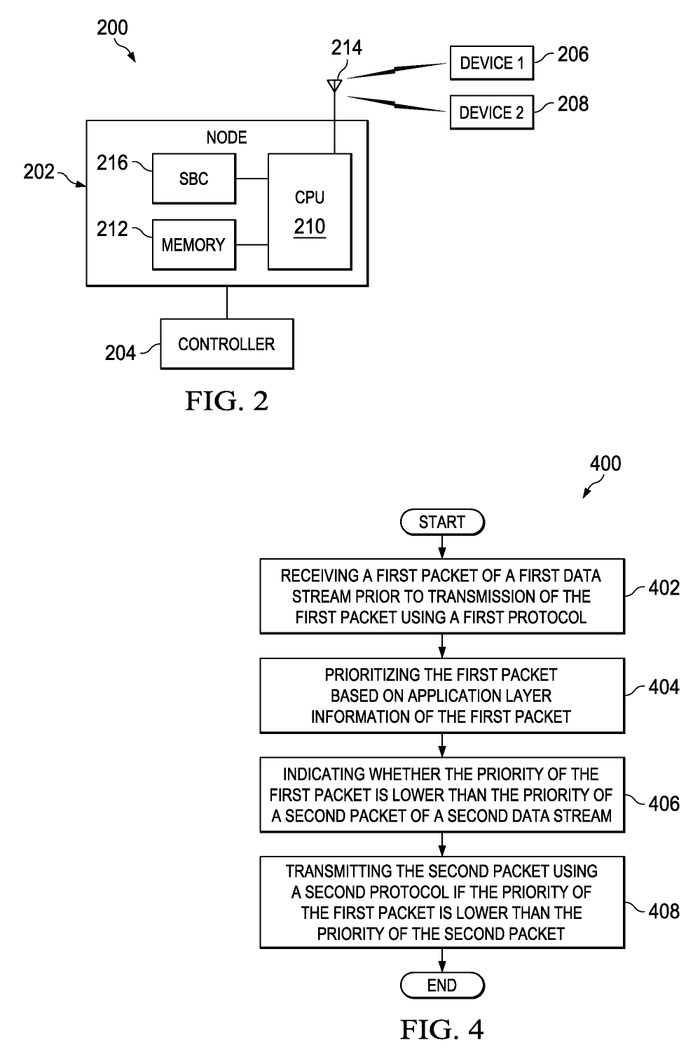

FIG. 2 shows a system 200 in accordance with various embodiments. A node 202 comprises a processor 210 coupled to a memory 212, a wireless transceiver 214 and a SBC 216. The wireless transceiver 214 may be an antenna configured to operate using more than one wireless protocol (e.g., WLAN and BT). The node 202 is additionally in communication with a controller 204. In some embodiments, the node 202 may couple to the controller 204 wirelessly by way of the wireless transceiver 214 where the controller 204 is a separate device from the node 202. In other embodiments, the controller 204 may be integrated into the node 202. In an exemplary embodiment, the controller 204 is implemented as computer hardware, such as a field-programmable gate array, or as computer software executed by a processor (e.g., CPU 210). The controller 204 is configured to determine the priority of packets to be transmitted by using higher layer information of those packets.

The node 202 is also wirelessly coupled to a first device 206 and a second device 208 by way of the wireless transceiver 214. In some embodiments, the first device 206 is configured to operate using a first protocol (e.g., BT) and the second device 208 is configured to operate using a second protocol (e.g., WLAN). In other embodiments, the first device 206 and the second device 208 may exist as a single device, which is configured to operate in both the first protocol and the second protocol (e.g., a coexistence device). FIG. 2 is exemplary, and the system of FIG. 2 may be adapted to include numerous nodes, controllers and devices as well as utilize numerous different protocols.

In an exemplary embodiment, the node 202 comprises a smart phone configured to operate using WLAN and BT, device 206 comprises a BT headset and device 208 comprises a WLAN access point (“AP”). A user of the node 202 is involved in two-way communications with a third-party speaker, and is additionally uploading content using WLAN. When the third-party speaker is communicating with the user (i.e., speaking into a device operated by the third party), the node 202 transmits BT voice data to the BT headset 206. However, before the node 202 transmits a voice data packet to the BT headset 206, the controller 204 determines whether the voice data packet is useful.

If the voice data packet represents a pause in speech of the third-party speaker, background noise or white noise, then the voice data packet is not useful, since it does not contribute to the user's understanding of the third-party speaker. In this case, the SBC 216 is configured output a dummy voice packet. This information can be passed in the application layer of the packet to the controller 204, which determines that the voice packet is not useful. In an exemplary embodiment, the SBC 216 passes this information in the application layer of a packet by setting a particular bit to “1” if the packet is a dummy voice packet. Thus, the controller 204 determines that the priority of the voice data packet is lower than the priority of the WLAN data packet to be transmitted based on the particular bit in the application layer of the packet being a “1”, and causes the node 202 to transmit one or more WLAN data packets (if present) to AP 208 instead of the BT voice data packet to BT headset 206.

Alternatively, if the voice data packet is useful (i.e., represents speech of the third-party speaker), then the SBC 216 does not output a dummy voice packet and passes this information to the controller in the application layer of the packet by setting the particular bit to “0.” Thus, the controller 204 determines that the priority of the voice data packet is higher than the priority of the WLAN data packet to be transmitted based on the particular bit in the application layer of the packet being a “0”, and causes the node 202 to transmit the BT voice data packet to the BT headset 206.

Thus, the controller 204 utilizes higher layer (e.g., application layer) information to determine the priority of the voice data packets. Although BT voice data generally is of high priority, the wireless transceiver 214 may be used for another medium (e.g., WLAN) if the controller 204 determines that the BT voice data is not useful. This increases the efficiency of the channel and enables finer granularity for packet prioritization.

In another exemplary embodiment, the node 202 comprises a smart phone configured to operate in WLAN and BT, device 206 comprises a BT device and device 208 comprises a device that is capable of downloading video data from the node 202 using WLAN. A user of the device 208 desires to download video from the node 202, or is downloading video from the node 202. Additionally, the node 202 is transmitting data to the BT device 206. However, before the node 202 transmits a video data frame to the device 208, the controller 204 determines whether the video data frame is an I-frame, P-frame, or B-frame.

If the application layer of the video data frame (e.g., video data frame header) indicates that the frame is a P-frame or a B-frame, then the frame does not substantially contribute to the recipient's comprehension of the video information. Thus, the controller 204 determines that the priority of the video data frame is lower than the priority of the BT data packet, and causes the node 202 to transmit the BT data packet to the BT device 206 instead of the video data frame to the device 208. Alternatively, if the video data frame is an I-frame, and thus substantially contributes to the recipient's comprehension of the video information, then the controller 204 determines that the priority of the video data frame is higher than the priority of the BT data packet to be transmitted, and causes the node 202 to transmit the video data frame to the device 208.

The controller 204 utilizes higher layer (e.g., application layer) information to determine the priority of the video data frames. The video frame header carries information that indicates the type of frame. Thus, although video information generally is of high priority, the wireless transceiver 214 may be used for another medium (e.g., BT) if the controller 204 determines that a video data frame is a P-frame or B-frame. This also increases the efficiency of the channel and enables finer granularity for packet prioritization.

In accordance with various embodiments, the controller 204 is configured to compare the priority of two packets to determine which packet should be transmitted. As explained above, the priorities are determined based on higher layer (e.g., application layer) information. Utilizing such information, rather than determining priority based on the packet type (e.g., voice data, video data), which is more generic, increases the efficiency of the channel and enables finer granularity for packet prioritization, since not all data packets of a particular type are high-priority packets. The controller 204 may assign the priority of a packet a numerical value, a Boolean value or any other value that allows for comparison to the priority of another packet. The memory 212 may contain a table of priorities for various packet types and packets having various attributes, which the controller 204 accesses to compare packet priorities. Upon determining which packet should be transmitted, the controller 204 may communicate an indication to the node 202, enabling the node 202 to transmit the appropriate packet using the appropriate medium (e.g., BT or WLAN).

In some embodiments, the node 202 is configured to operate in a time-divided manner, where the node periodically operates using one of multiple protocols (e.g., WLAN and BT). FIG. 3a shows a timeline 300 representing such operation. In one period, the node 202 operates using both protocols sequentially (i.e., first operates in a WLAN mode 302 and then operates in a BT mode 304). If the controller 204 determines that the priority of a BT packet is greater than the priority of a WLAN packet that will be transmitted in the coming WLAN mode 306 the node 202 may choose, for example, not to switch to WLAN mode and continue to operate in BT mode to enable transmission of the BT packet having a higher priority. FIG. 3b shows the resulting timeline 350. Instead of operating in WLAN mode 306, the node 202 operates in an additional BT mode 356 because of the determination that the priority of a pending BT packet was greater than the priority of the WLAN packet that would have been transmitted in WLAN mode 306.

However, another device 208 may expect the node 202 to be operating in a periodic manner as shown in FIG. 3a, and thus expect that, at a given time, the node 202 is operating in a particular protocol (e.g., WLAN mode 306). If the node 202 is operating in a different protocol (e.g., BT mode 356), as shown in FIG. 3b, because of a priority determination and the device 208 sends a data packet to the node 202, the node 202 will not process the data packet and will not send an acknowledgement of receipt to the device 208. The device 208 expects a subsequent acknowledgment from the node 202, and thus a rate-fall back mechanism is triggered by the device 208. This rate-fall back mechanism reduces the transmission rate used to send WLAN data packets from the device 208 to the node 202, causing the WLAN data packets transmitted to occupy longer time intervals. This, in turn, may lead to conflict with the use of the medium by the BT mode. As a result, the performance of the node 202 in both BT and WLAN modes deteriorates. Such deterioration may be referred to as the “avalanche effect.”

To avoid the “avalanche effect,” the node 202 transmits or broadcasts a frame that reserves the network for a period of time, thus preventing a transfer of data from the device 208 to the node 202 during BT mode 356 that results from the determination that a BT data packet has a higher priority than another data packet. The frame is transmitted during BT mode 354 and effectively quiets other devices in the network for a specified time. In this case, the specified time is the duration of BT mode 356. In some instances, this frame may take the form of a CTS2Self frame. To reserve the network for the appropriate period of time, the CTS2Self frame must accurately indicate the size (i.e., duration) of the BT data packet that is being transmitted in BT mode 356. The controller 204 utilizes higher layer (e.g., application layer) information of the BT data packet to determine the size of the BT data packet and causes the node 202 to transmit or broadcast a CTS2Self frame that correctly indicates the duration (i.e., BT data packet size divided by a known transmission rate) of the coming BT time period 356.

FIG. 4 shows a method 400 in accordance with various embodiments. The method begins when a controller 204 receives a first packet of a first data stream prior to transmission, by a node 202, of the first packet using a first protocol (e.g., BT) (block 402). The controller 204 may receive the first packet by way of the wireless transceiver 214 or by way of a direct connection to the node 202 if the controller 204 is part of the node 202.

The method continues when the controller 204 prioritizes the first packet based on higher layer (e.g., application layer) information of the first packet (block 404). In an exemplary embodiment, the first packet may be a BT voice data packet and the SBC 216 may indicate whether the voice data packet contains useful information. The indication can be a “0” or “1” bit passed to the controller by the SBC codec. As discussed above, if the voice data packet corresponds to a pause in speech, background noise or white noise, then the voice data packet does not contain useful information.

In another exemplary embodiment, the first packet may be a video packet to be transmitted using WLAN and the application layer information may indicate whether the video data frame is an I-frame, P-frame, or B-frame. This can be determined by decoding the header of the video frame. As discussed above, if the video data frame is a P-frame or a B-frame, and thus does not substantially contribute to the recipient's comprehension of the video information, then the video data frame does not contain useful information and should have a low priority.

The method continues when the controller 204 indicates to the node 202 whether the priority of the first packet is lower than the priority of a second packet (block 406). The indication may take the form of a signal or message that the node 202 is configured to interpret as indicating the priority of a packet prior to transmission of the packet. The indication of priority of a packet may be a numerical value, a Boolean value or another value that allows for comparison to the priority of another packet. The node 202 then transmits the second packet using a second protocol if the priority of the first packet is lower than the priority of the second packet (block 408). For example, if the higher-priority packet is a BT data packet, then the controller 204 causes the node 202 to transmit the BT data packet using BT. Conversely, if the higher-priority packet is a WLAN data packet, then the controller 204 causes the node 202 to transmit the WLAN data packet using WLAN. The method then ends.

In an exemplary embodiment, the first packet is of a first data stream type, the second packet is of a second data stream type and first data stream type has a higher priority than the second data stream type. However, the priority of an individual packet is determined based on higher layer information, rather than what type the packet is. As a result, the controller 204 may determine that a packet of a high-priority data stream type but that is not useful to the recipient's comprehension of the transmitted information has a low priority. Thus, the controller 204 may indicate this to the node 202 so that the node 202 transmits the second packet, despite being of a lower-priority data stream type.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system comprising:
a node configured to transmit a first data stream to a first device using a first protocol and a second data stream to a second device using a second protocol;
a controller in communication with the node;
wherein the controller is configured to prioritize a first packet of the first data stream, prior to transmission of the first packet, based on application layer information of the first packet;
wherein the controller causes the node to transmit a second packet of the second data stream if the application layer information of the first packet indicates that the priority of the first packet is lower than the priority of the second packet.

2. The system of claim 1 wherein the first packet further comprises a voice data packet and the application layer information of the voice data packet indicates whether the voice data is useful.

3. The system of claim 2 wherein the priority of the voice data packet is lower than the priority of the second packet if the voice data is not useful.

4. The system of claim 1 wherein the first packet comprises a video data frame and the application layer information of the video data frame indicates whether the video data frame is an I-frame, P-frame, or B-frame.

5. The system of claim 4 wherein the priority of the video data frame is lower than the priority of the second packet if the video data frame is a P-frame or a B-frame.

6. The system of claim 1 wherein the controller determines a size, prior to transmission, of the packet to be transmitted based on application layer information of the packet to be transmitted.

7. The system of claim 6 wherein the controller causes the node to broadcast a CTS2Self message that reserves a transmission medium of the packet to be transmitted for the duration of the packet to be transmitted.

8. The system of claim 1 wherein:
the node is configured to operate using the first protocol in a first time period and is configured to operate using the second protocol in a second time period; and
if the controller causes the node to transmit the packet having a higher priority then the controller causes the node to operate in the second protocol in the first time period or to operate in the first protocol in the second time period.

9. The system of claim 1 wherein the first data stream has a higher priority than the second data stream and the node is configured to transmit the data stream having a higher priority;

10. A system comprising:
a controller configured to:
prioritize a first packet prior to transmission of the first packet using a first protocol;
prioritize a second packet prior to transmission of the second packet using a second protocol;
compare the priorities of the first and second packets; and
indicate the packet having a higher priority;
wherein the controller determines the priority of at least one of the first packet and the second packet based on application layer information of the at least one of the first packet and the second packet.

11. The system of claim 10 wherein the first packet further comprises a voice data packet and the application layer information of the voice data packet indicates whether the voice data is useful.

12. The system of claim 11 wherein the priority of the voice data packet is below the priority of the second packet if the voice data is not useful.

13. The system of claim 10 wherein the first packet comprises a video data frame and the application layer information of the video data frame indicates whether the video data frame is an I-frame, P-frame, or B-frame.

14. The system of claim 13 wherein the priority of the video data frame is below the priority of the second packet if the video data frame is a P-frame or a B-frame.

15. A method comprising:
receiving, by a controller, a first packet of a first data stream prior to transmission of the first packet using a first protocol;
prioritizing, by the controller, the first packet based on application layer information of the first packet;
indicating, by the controller to a node, whether the priority of the first packet is lower than the priority of a second packet of a second data stream; and
transmitting, by the node, the second packet using a second protocol if the priority of the first packet is lower than the priority of the second packet.

16. The method of claim 15 wherein a data stream type of the first packet has a higher priority than a data stream type of the second packet.

17. The method of claim 15 wherein the first packet comprises a voice data packet and the application layer information of the voice data packet indicates whether the voice data is useful.

18. The method of claim 17 wherein the priority of the voice data packet is below the priority of the second packet if the voice data is not useful.

19. The method of claim 15 wherein the first packet comprises a video data frame and the application layer information of the video data frame indicates whether the video data frame is an I-frame, P-frame, or B-frame.

20. The method of claim 19 wherein the priority of the video data frame is below the priority of the second packet if the video data frame is a P-frame or a B-frame.

21. The method of claim 15 further comprising:
determining, by the controller and prior to transmitting, a size of the packet having a higher priority;
determining, by the controller and prior to transmitting, a duration of the packet having a higher priority based on the size of the packet having a higher priority; and
broadcasting, by the node and prior to transmitting the packet, a CTS2Self message that reserves a transmission medium of the packet having a higher priority for the duration of the packet having a higher priority.

22. The method of claim 21 wherein determining the size further comprises determining the size based on application layer information of the packet having a higher priority.

23. The method of claim 15 further comprising:
using, by the node, the first protocol in a first time period; and
using, by the node, the second protocol in a second time period;
wherein transmitting the packet having a higher priority causes using the second protocol in the first time period or using the first protocol in the second time period.
